(19) United States
(12) Patent Application Publication
(10) Pub. No.: US 2019/0075826 A1
(43) Pub. Date: Mar. 14, 2019

(54) ELECTROMAGNETIC WAVE FOOD PROCESSING SYSTEM AND METHODS

(71) Applicant: Campbell Soup Company, Camden, NJ (US)

(72) Inventors: Rasheed Mohammed, Sicklerville, NJ (US); Mark Robert Watts, Marlton, NJ (US); Scott Wayne Keller, Medford, NJ (US)

(21) Appl. No.: 16/130,730

(22) Filed: Sep. 13, 2018

Related U.S. Application Data
(60) Provisional application No. 62/558,548, filed on Sep. 14, 2017.

(51) Int. Cl. A23L 3/01; H05B 6/78; H05B 6/64; H05B 6/80; A23L 3/015; A23L 3/04

(52) U.S. Cl. CPC A23L 3/01; H05B 6/782; H05B 6/6402; A23V 2002/00; A23L 3/0155; A23L 3/045; H05B 6/804

(57) ABSTRACT

Embodiments herein include processing systems for food products and related methods. In an embodiment, the processing system includes a housing and a product conveyor. The housing defines a processing channel that includes an electromagnetic wave heating chamber. The electromagnetic wave heating chamber is at least partially filled with a fluid, such as a fluid. The conveyor mechanism can convey food products continuously along a conveyance path including a serpentine pathway that includes a plurality of hairpin corners where a direction of the conveyance path is reversed and a depth of the conveyance path is increased. The electromagnetic wave emitting apparatus emits electromagnetic energy into the pathway. The average pressure in the electromagnetic wave heating chamber changes along the conveyor mechanism. The orientation of products along the conveyance path varies minimally along at least portions of the conveyance path. Other embodiments are also included herein.

This application claims the benefit of U.S. Provisional Application No. 62/558,548 filed Sep. 14, 2017, the content of which is hereby incorporated by reference in its entirety.

### FIELD

Embodiments herein relate to electromagnetic wave food processing systems and methods.

### BACKGROUND

Most food products have a tendency to spoil relatively quickly. As such, preservation techniques have been developed over many years to extend the amount of time that a given food product will remain fresh. Food preservation techniques can include dehydrating, freezing, fermenting, pickling, acidification, curing, canning, heat treating, retort sterilization, irradiating, chemical preservation and the like.

Retort sterilization typically involves the application of heat to hermetically sealed packages of food through thermal conduction. Retort sterilization allows for packaged non-frozen and non-dehydrated ready-to-eat foods that can have a shelf life of months to years.

While food preservation techniques, such as retort sterilization, have been successful at preventing food spoilage, it has been found that such techniques can have adverse effects on food products including, diminishing taste and appearance, reducing nutritional qualities, and the like.

### SUMMARY

Embodiments herein include electromagnetic wave (including, but not limited to microwave and/or radiofrequency wave) processing systems for food products and related methods. In an embodiment, a food processing system is included. The food processing system includes a housing defining a processing channel. The processing channel can include an electromagnetic wave heating chamber. The electromagnetic wave heating chamber can be configured to be at least partially filled with a fluid. A product conveyor mechanism can be used to convey food products to be processed continuously along a conveyance path passing through the electromagnetic wave heating chamber. The conveyance path can include a serpentine pathway, the serpentine pathway can include a plurality of hairpin corners wherein a horizontal direction of the conveyance path is reversed and a depth of the conveyance path is increased. An electromagnetic wave emitting apparatus can be configured to emit electromagnetic energy into the serpentine pathway, the electromagnetic wave emitting apparatus comprising a plurality of wave emitting units. The average pressure in the electromagnetic wave heating chamber can change along the path of the conveyor mechanism. The orientation of products carried along the conveyance path can vary by less than 15 degrees when passing through each hairpin corner.

In an embodiment, a method for sterilizing food products is included. The method can include loading food products to be processed onto a conveyor and passing the food products into a fluid filled electromagnetic wave heating chamber by movement of the conveyor. The electromagnetic wave heating chamber can define a conveyance path, the conveyance path comprising a serpentine pathway. The serpentine pathway can include a plurality of hairpin corners wherein a horizontal direction of the conveyance path is reversed and a depth of the conveyance path is increased. The electromagnetic wave heating chamber further includes an electromagnetic wave emitting apparatus configured to emit electromagnetic energy into the serpentine pathway, the electromagnetic wave emitting apparatus comprising a plurality of wave emitting units. The method can further include heating the food products with electromagnetic wave energy from the emitters as the food products pass through the main electromagnetic wave heating chamber.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following drawings, in which:

FIG. 1 is a flow chart showing operations that can be performed in accordance with various embodiments herein.

FIG. 2 is a schematic side view of a processing system in accordance with various embodiments herein.

FIG. 3 is a schematic side view of a processing system in accordance with various embodiments herein.

FIG. 4 is a schematic side view of a processing system in accordance with various embodiments herein.

FIG. 5 is a schematic side view of a processing system in accordance with various embodiments herein.

FIG. 6 is a schematic side view of a processing system in accordance with various embodiments herein.

FIG. 7 is a schematic side view of a main electromagnetic wave heating chamber in accordance with various embodiments herein.

FIG. 8 is a schematic side view of a main electromagnetic wave heating chamber in accordance with various embodiments herein.

FIG. 9 is a schematic side view of a main electromagnetic wave heating chamber in accordance with various embodiments herein.

FIG. 10 is a schematic side view of a processing system in accordance with various embodiments herein.

FIG. 11 is a schematic side view of a processing system in accordance with various embodiments herein.

FIG. 12 is a schematic side view of an electromagnetic wave unit in accordance with various embodiments herein.

FIG. 13 is a schematic side view of a processing system in accordance with various embodiments herein.

FIG. 14 is a schematic side view of a processing system in accordance with various embodiments herein.

FIG. 15 is a schematic side view of a processing system in accordance with various embodiments herein.

FIG. 16 is a schematic side view of a processing system in accordance with various embodiments herein.

FIG. 17A is a schematic side view of a processing system in accordance with various embodiments herein.

FIG. 17B is a schematic side view of a processing system in accordance with various embodiments herein.

FIG. 18 is a schematic end view of a processing system in accordance with various embodiments herein.

FIG. 19 is a schematic end view of a processing system in accordance with various embodiments herein.

FIG. 20 is a schematic side view of a food product in accordance with various embodiments herein.

FIG. 21 is a flow chart showing operations that can be performed in accordance with various embodiments herein.

While embodiments are susceptible to various modifications and alternative forms, specifics thereof have been shown by way of example and drawings, and will be described in detail. It should be understood, however, that the scope herein is not limited to the particular embodiments described. On the contrary, the intention is to cover modifications, equivalents, and alternatives falling within the spirit and scope herein.

### DETAILED DESCRIPTION

In various embodiments, the system can be configured to ensure that the orientation of the food products with respect to the vertical and horizontal axes is substantially constant as the products move along a conveyance path through the system. For example, the system can be configured to prevent the food products from flipping over or substantially rotating with respect to the vertical and/or horizontal axes as they move along the conveyance path. In some embodiments, orientation constancy can be maintained throughout the whole electromagnetic wave heating chamber. In other embodiments, orientation constancy is maintained throughout at least a portion (e.g., 50%, 75%, 90% or 95% of the distance travelled) of the electromagnetic wave heating chamber. In some embodiments, orientation constancy can be maintained throughout the entire system including, but not limited to, various chambers or zones that can form the system such as one or more come-up chambers or zones, one or more electromagnetic wave heating chambers, one or more cool-down chambers or zones, one or more hold chambers or zones, and the like.

As used herein, the term “food product” shall include both foods of all types as well as drinks of all types, unless used explicitly to the contrary. Food products herein can include shelf-stable food products, extended shelf-life products, ready-to-eat food products, chilled food products, refrigerated food products, and the like. Food products herein can include acidified and non-acidified food products. By way of example, food products can include food products having a pH of below 4.6 as well as food products having a pH of 4.6 or higher. Food products herein can include high nutritional density food products. Food products herein can include human food products, pet food products, geriatric food products, food products for at-risk populations, baby food products, nutriceuticals, and the like. Food products herein can include, but are not limited to, soups, soups with particulates, sauces, concentrates, condiments, salsas, dips, fruits, vegetables, nut products, grain products, pasta products, food components or ingredients, beverages of all types, dairy products, meat products, fish products, entrees, combinations of any of these, and the like. Food products herein can also specifically include those that include a first type of food in a first portion of a package and a second type of food in a second portion of a package separated from the first portion.

As used herein, the term “food package” shall be synonymous with the term “food container”. Food packages/containers can include many different types including, but not limited to, jars, cans, bottles, bowls, trays, multi-pack packages, bags, sleeves, pouches, and the like. Food packages/containers can be rigid, semi-rigid, semi-flexible, or flexible. In various embodiments the food packages herein can be substantially transparent to microwave energy and/or radiofrequency wave energy. In various embodiments portions of food packages herein can be substantially transparent to microwave energy and/or radiofrequency wave energy while other portions can absorb or reflect such energy.

It will be appreciated that systems and methods herein can be used for both sterilization and pasteurization processes. References to “processing” of food items herein shall include both sterilization and pasteurization unless the context dictates otherwise.

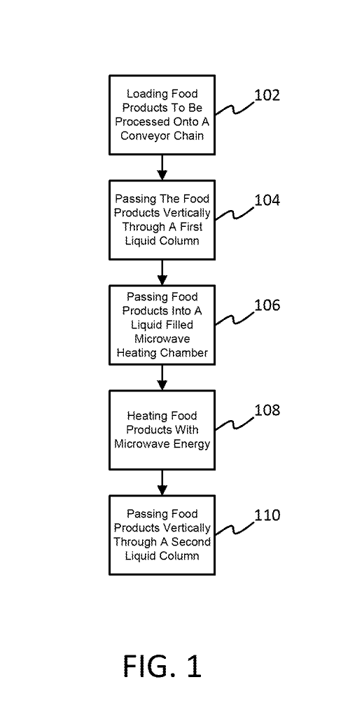

Referring now to FIG. 1, aspects of an embodiment are shown. In a one operation the system or method can include loading food products (within food packages) to be processed onto a conveyor mechanism 102. The conveyor mechanism 102 can include, but is not limited to, a conveyor chain, conveyor belt, conveyor track, or the like. In some embodiments, the temperature of the food products as they are being fed into the system can be from about −20 degrees Fahrenheit to about 300 degrees Fahrenheit, though the temperature of such products is not limiting. In some embodiments, the food products can be loaded onto the conveyor mechanism automatically, as fed from a conveyor belt, guide rail, or the like. In other embodiments the food products can be loaded manually.

In some embodiments, the conveyor mechanism or portions thereof can extend continuously (e.g. uninterrupted physically) throughout the various chambers of the system. In some embodiments, the conveyor mechanism can form a continuous loop. The conveyor mechanism can be of sufficient size and move with sufficient speed as to provide sufficient time for the system to rapidly heat the food product inside the food package, while preventing or reducing the potential for hot spots on the packaging itself as well as hotspots within interior areas of the food product. In some embodiments, the conveyor mechanism moves continuously. In some embodiments, the conveyor mechanism moves discontinuously. By way of example, the movement of food products through the system could include intermittent stops. In some embodiments, such intermittent stops can be in synchrony with electromagnetic wave emitters of the system switching between on and off modes, such that electromagnetic wave energy is provided in a pulsed manner.

In some embodiments, the conveyor mechanism moves with a constant speed. In other embodiments, the conveyor mechanism moves with a varying speed depending on factors such as the alignment or non-alignment of food products with electromagnetic wave units and/or components thereof.

Some embodiments of systems herein can process food products at a higher rate than previous systems. In some embodiments, systems herein can be configured to process from 1 to 3000 or more food containers per minute. In some embodiments, the system can be configured to process food containers at a speed greater than 500 containers per minute. In some embodiments, the system can be configured to process food containers at a speed greater than 750 containers per minute. In some embodiments, the system can be configured to process food containers at a speed greater than 1000 containers per minute. In some embodiments, the system can be configured to process food containers at a speed greater than 1250 containers per minute. In some embodiments, the system can be configured to process food containers at a speed greater than 1500 containers per minute. In some embodiments, the system can be configured to process food containers at a speed greater than 1750 containers per minute. In some embodiments, the system can be configured to process food containers at a speed greater than 2000 containers per minute. In some embodiments, the system can be configured to process food containers at a speed greater than 2250 containers per minute. In some embodiments, the system can be configured to process food containers at a speed greater than 2500 containers per minute. In some embodiments, the system can be configured to process food containers at a speed greater than 2750 containers per minute. In some embodiments, the system can be configured to process food containers at a speed greater than 3000 containers per minute.

In some embodiments, the conveyor mechanism can include mechanical holding elements to connect the food products to the conveyor mechanism. By way of example, mechanical holding elements can include, but are not limited to, trays, baskets, cages, clips, hooks, brackets and the like. For example, in some embodiments a plurality of retaining trays can be attached to the product conveyor mechanism. In some embodiments, the conveyor mechanism can accommodate multiple food products arranged laterally across the conveyor mechanism transverse to the axis of motion. For example, retaining trays attached to the product conveyor belt can be configured to hold a plurality of individual food containers laterally across the tray. In some embodiments, the arrangement of multiple food products laterally across the conveyor mechanism with one or more mechanical holding elements can be referred to as a “flight”.

In another operation the system or method can include passing the food products vertically through a first fluid column by movement of the conveyor mechanism 104. It will be appreciated that, due to the force of gravity, the deeper one goes in a column of a fluid the higher the pressure is, all other things being equal. Rather than separating an area of higher pressure from an area of lower pressure with a sealing mechanical element such as a gate or a door, such areas of differing pressure can be separated with a column of a fluid such as water. As such, by passing the food products vertically, and specifically downward, through a first fluid column the food products can be exposed to an environment of higher pressure. In some embodiments, passing the food products downward through a first fluid column can also include preheating the food products through direct contact of the packages of food products with a medium that is at a higher temperature than the food products. However, other means of preheating the food products are also contemplated herein. In some embodiments, the food products can be passed through additional columns of water upstream of the main electromagnetic wave heating chamber in order to increase pressure further while limiting the total height of any one fluid column.

In another operation the system or method can include passing the food products into a main electromagnetic wave heating chamber by movement of the conveyor mechanism 106. In many embodiments, the main electromagnetic wave heating chamber can be fluid filled. However, in some embodiments, at least a portion of the main electromagnetic wave heating chamber can be filled with a gas, such as steam.

In some embodiments, the main electromagnetic wave heating chamber is completely filled with fluid at a pressure above 0 psig. In some embodiments, the average pressure in the main electromagnetic wave heating chamber is from about 0 psig to about 60 psig. In some embodiments, the average pressure in the main electromagnetic wave heating chamber is from about 0 psig to about 60 psig. In some embodiments, the pressure can be applied to accommodate off-setting of the internal pressure of the package to the internal pressure of the system so as to balance between the two for an acceptable variation range that prevents permanent deformation of the food package or destruction of the food package in the system.

Various components can be disposed within or adjacent to the main electromagnetic wave heating chamber. By way of example, sensors (including, but not limited to, temperature sensors, electromagnetic wave energy sensors, pressure sensors, proximity or distance sensors, optical sensors, ultrasonic sensors, infrared sensors, and the like) can be disposed within or adjacent to the main electromagnetic wave heating chamber.

In some embodiments, the maximum height of fluid in the main electromagnetic wave heating chamber is lower than the maximum height of fluid in the come-up chamber and the cool-down chamber.

In another operation the system or method can include heating the food products with electromagnetic wave energy 108. The heat generated by the electromagnetic wave energy, in addition to heat that may be picked up by the food packages in the system (such as through conduction of heat from fluids such as fluids or gases surrounding food packages), can be sufficient to inactivate microorganisms.

In some embodiments, the amount of heat transferred to the food packages can include contributions through processes of conduction, convection, and/or radiation. Beyond the application of electromagnetic wave radiation and the contributions of fluids or gases surrounding the food packages, other methods of applying heat that can be used in various embodiments herein include the application of radiofrequency based heating, infrared based heating mechanisms, and other electromagnetic wave based mechanisms.

In some embodiments, the heat generated by the electromagnetic wave energy, in addition to heat that may be picked up by the food packages in the system, can be sufficient to pasteurize the food products. In some embodiments, the heat generated by the electromagnetic wave energy, in addition to heat that may be picked up by the food packages in the system, can be sufficient to sterilize the food products.

By way of example, in some embodiments, the food products can be sufficiently processed so as to achieve a 1 log, 2 log, 3 log, 4 log, 5 log, or 6 log reduction or greater in viable, vegetative microorganisms. In some embodiments the food products can be sufficiently processed so as to achieve a 1 log, 2 log, 3 log, 4 log, 5 log, or 6 log or greater reduction in microorganism spores. In some embodiments the food products can be sufficiently processed so as to achieve a 12 log reduction in spores, such as Clostridium botulinum. In some embodiments the food products can be sufficiently processed so as to achieve commercial pasteurization or commercial sterilization. The system can include a controller module and a controller program to calculate the total dosage of electromagnetic wave energy and determine if the prescribed lethality was achieved per station as well as total lethality.

In various embodiments, the residence time of food product containers in the system can be from greater than 0 seconds to 150 minutes. In various embodiments, the residence time of food product containers in the system can be less than 150 minutes, 120 minutes, 90 minutes, 60 minutes, 45 minutes, 40 minutes, 35 minutes, 30 minutes, 25 minutes, 20 minutes, 15 minutes, 10 minutes, or 5 minutes. In some embodiments, the residence time of food product containers in the system can be in a range wherein any of the preceding numbers can form the upper or lower bound of the range provided that the upper bound is larger than the lower bound. In various embodiments, the residence time of food product containers in the main electromagnetic wave heating chamber can be from greater than 0 seconds to 120 minutes.

In various embodiments, the total time that food product containers are exposed to electromagnetic wave energy from 1 minute to 60 minutes. In various embodiments, the total time that food product containers are exposed to electromagnetic wave energy from 1 minute to 30 minutes. In various embodiments, the total time that food product containers are exposed to electromagnetic wave energy can be from 5 minutes to 20 minutes. In various embodiments, the total time that food product containers are exposed to electromagnetic wave energy is less than 15 minutes.

In another operation, the system or method can include passing the food products vertically through a second fluid column by movement of the conveyor mechanism 110. By passing the food products vertically, and in this case specifically upward, through a second fluid column the food products can be brought back into an environment of lower pressure (relative to the pressure in the main electromagnetic wave heating chamber). In some embodiments, passing the food products upward through a second fluid column can also include cooling the food products through direct contact of the packages of food products with a medium that is at a lower temperature than the food products. However, other means of cooling the food products are also contemplated herein. In some embodiments, the food products can be passed through additional columns of water downstream of the main electromagnetic wave heating chamber in order to decrease pressure further while limiting the total height of any one fluid column.

Other operations can also be conducted beyond those mentioned above. By way of example, in some embodiments, after passing through the main electromagnetic wave heating chamber and though one or more columns of a fluid, the food products can pass through an air cooling apparatus, such as an atmospheric pressure cooling tower, to further cool the food products. Many other operations are also contemplated herein.

In embodiments where there is fluid in the come-up chamber, main electromagnetic wave heating chamber, and/or the cool-down chamber, the fluids in those respective chambers can be the same or different from one another. In some embodiments, the fluid is a liquid. In some embodiments, the fluid is a polar liquid. In some embodiments, the fluid is a non-polar liquid. In some embodiments, the liquid is water. In some embodiments, the liquid is a non-aqueous liquid. In some embodiments, the liquid is polyethylene glycol. In some embodiments, the fluid is a mixture of components. In some embodiments the total dissolved solids and total suspended solids of the fluid is maintained within a predetermined range. In some embodiments, the fluid can have a total dissolved solids (TDS) concentration of between 100 mg/L and 1,500 mg/L. In some embodiments, the fluid can have a total suspended solids (TSS) concentration of between 1 mg/L and 1,500 mg/L or between 100 mg/L and 1,500 mg/L. In some embodiments, the fluid can have a pH of between 6.5 and 8.5 or between 6.5 and 7. In some embodiments, the fluid can have a residual free chlorine, free bromine, and/or free iodine content of between 0.01 and 8 ppm (as measured by each component or in the aggregate). In some embodiments, water conductivity is continuously monitored to maintain it between predetermined specification limits, such as between 1 and 600 μs.

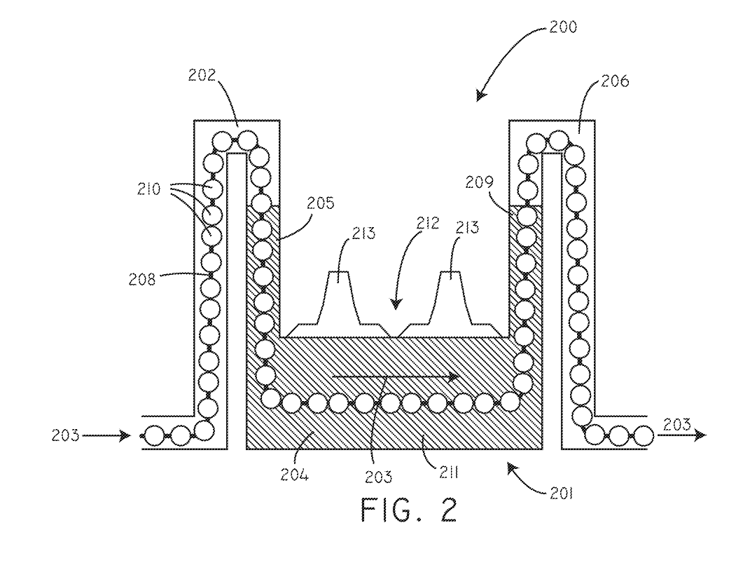

Referring now to FIG. 2, a schematic side view of a processing system 200 in accordance with various embodiments herein is shown. The processing system 200 includes a continuous processing channel 201. The continuous processing channel 201 can include a come-up chamber or zone 202. In some embodiments, the come-up chamber can include the initial application of heat to food products and thereby raising the temperature of the food products. In some embodiments, the come-up chamber can include increasing the pressure to which the food products are exposed. The continuous processing channel can also include a main electromagnetic wave heating chamber or zone 204 and a cool-down chamber or zone 206 (or in cases where cooling is not done at this stage an output chamber).

The come-up chamber 202 can be oriented for vertical product movement. In specific, the come-up chamber 202 can be oriented for vertical movement of food products (or trays or flights of food products) 210 along a product conveyor mechanism 208 through the continuous processing channel 201 of the processing system 200 in the direction of arrows 203. In some embodiments, an actuator or similar mechanism can be disposed within the come-up chamber 202 in order to cause rotation (such as axial rotation) of the food products.

Various mechanisms can be used to begin warming the food products within the come-up chamber 202. By way of example, an electromagnetic wave emitter array can be positioned to begin heating products within the come-up chamber 202. In some embodiments, the fluid within the come-up chamber 202 can itself be heated in order to transfer heat to the food products through conduction.

The come-up chamber 202 can include a fluid column 205. In this case, the fluid column 205 is in fluid communication with the main electromagnetic wave heating chamber 204. The fluid column 205 exerts a force downward onto the fluid in the main electromagnetic wave heating chamber 204 such that the pressure in the main electromagnetic wave heating chamber 204 is higher than in the area above the fluid column 205 (for example, in many cases above atmospheric pressure). In some embodiments, the maximum pressure within the come-up chamber 202 is from about 0 psig to about 60 psig. In some embodiments, the temperature of the fluid in the come-up chamber 202 can be from about 32 degrees Fahrenheit to about 300 degrees Fahrenheit.

The height of the come-up chamber 202 can vary. In general, the taller the come-up chamber is, the taller the water column(s) therein can be. As such, the height can vary depending on the desired water column height which in turn can vary based on desired pressures. However, in some embodiments the height of the come-up chamber can be greater than about 2, 4, 6, 8, 10, 15, 20, 25, 30, 40, 50, 60, 70, or 100 feet. In some embodiments, the height of the come-up chamber can be in a range wherein each of the foregoing numbers can serve as the lower or upper bound of the range provided that the upper bound is higher than the lower bound.

In some embodiments the height of one or more water columns in the come-up chamber can be greater than about 1, 3, 5, 7, 9, 14, 19, 24, 29, 39, 49, 59, 69, or 99 feet. In some embodiments, the height of one or more water columns in the come-up chamber can be in a range wherein each of the foregoing numbers can serve as the lower or upper bound of the range provided that the upper bound is higher than the lower bound.

In some embodiments, the come-up chamber 202 can be substantially air-tight except for the area where food products enter the come-up chamber 202 and the area where food products exit the come-up chamber 202. In some embodiments, access hatches or ports (including but not limited to fluid exchange ports) and/or observation windows can be included at various points along the path of the come-up chamber 202.

Food products 210 can be moved by the product conveyor mechanism 208 from the come-up chamber 202 and into a following chamber such as the main electromagnetic wave heating chamber 204. It will be appreciated, however, that in some embodiments food products may enter a holding chamber before entering the main electromagnetic wave heating chamber 204. The main electromagnetic wave heating chamber 204 can be filled with a fluid 211. The processing system 200 can include an electromagnetic wave energy emitting apparatus 212 in order to deliver electromagnetic wave energy to the main electromagnetic wave heating chamber 204. In some embodiments, an actuator or similar mechanism can be disposed within the electromagnetic wave heating chamber 204 in order to cause rotation (such as axial rotation) of the food products. However, in other embodiments, the conveyor mechanism 208 in the main electromagnetic wave heating chamber 204 is designed to hold the food products in a substantially static plane.

In some embodiments, the head space above the food products in the main electromagnetic wave heating chamber 204 (e.g., distance between the top of the food product and the inner wall of the electromagnetic wave heating chamber above the food product) is relatively small. By way of example, the head space can be less than about 50 cm, 40 cm, 30 cm, 20 cm, 10 cm, 5 cm, or 1 cm. In some embodiments, the head space can be greater than about 0.2 cm, 0.5 cm, 0.8 cm, 1 cm, 1.5 cm, 2 cm, 3 cm, or 5 cm. In some embodiments, the head space can be in a range with any of the preceding numbers representing the lower and upper bounds of the range provided that the upper bound is larger than the lower bound.

In some embodiments, the main electromagnetic wave heating chamber 204 can be substantially air-tight except for the area where food products enter the main electromagnetic wave heating chamber 204 and the area where food products exit the main electromagnetic wave heating chamber 204. In some embodiments, access hatches or ports (including but not limited to fluid exchange ports) and/or observation windows can be included at various points along the path of the main electromagnetic wave heating chamber 204.

In some embodiments, the temperature of the fluid in the electromagnetic wave heating chamber 204 can be from about 32 degrees Fahrenheit to about 300 degrees Fahrenheit. In some embodiments, the fluid temperature can be stabilized to a target temperature using a heat exchanger, heat regulator, heating device, cooling device, etc.

The electromagnetic wave energy emitting apparatus 212 can include one or more electromagnetic wave units 213. In some embodiments, each electromagnetic wave unit 213 can be separate from one another and can each have their own generator (such as a magnetron or other generator), emitter, waveguide, horn, waveguide cover, etc. In other embodiments, electromagnetic wave units 213 can share one or more components such as a shared generator or other source (such as a shared magnetron). In some embodiments, the electromagnetic wave units 213 can be arranged into an array. By way of example, in some embodiments, the electromagnetic wave energy emitting apparatus 212 can include from 1 to 400 electromagnetic wave units 213, from 1 to 100 electromagnetic wave units 213, or from 1 to 40 electromagnetic wave units 213. In some embodiments, the electromagnetic wave units 213 can be arranged into a grid. By way of example, in some embodiments herein, the system can include from 1 to 40 electromagnetic wave generators (such as magnetrons) and from 1 to 400 electromagnetic wave emitters.

In some embodiments, the electromagnetic wave units can be placed at varied distances from each other to allow food product within each food package to equilibrate in temperature before traveling under the next electromagnetic wave unit. In contexts where it is relevant, the equilibrium period could range from 1 second to 20 minutes. In some embodiments, the speed of the conveyor mechanism can be changed to accommodate a desired thermal equilibration time. By way of example, in some embodiments, the conveyor mechanism can be stopped or slowed down to accommodate a desired thermal equilibration time.

In some embodiments, the electromagnetic wave energy emitting apparatus 212 can be configured to emit energy continuously. In some embodiments, the electromagnetic wave energy emitting apparatus 212 can be configured to emit energy intermittently. In some embodiments, the intensity of the emitted energy can be constant. In some embodiments, the intensity of the emitted energy can be varied. In some embodiments, the electromagnetic wave energy emitting apparatus 212 can be configured to emit energy in response to one or more triggering events, such as when food products pass a triggering sensor.

In some embodiments, the electromagnetic wave units 213 can emit microwave energy at a frequency from approximately 300 MHz to approximately 2550 MHz or between 800 MHz to approximately 2550 MHz. In some embodiments, the electromagnetic wave units 213 can emit microwave energy at a frequency from approximately 915 MHz or approximately 2450 Mhz. In some embodiments, all electromagnetic wave units 213 can emit electromagnetic wave energy at a common frequency. In other embodiments, electromagnetic wave units 213 can emit energy at different frequencies. For example, the electromagnetic wave units 213 can emit microwave energy at a first frequency of approximately 915 MHz and a second frequency of approximately 2450 Mhz. It is believed that higher frequencies, such as around 2450 MHz, can be useful for surface related effects such as browning, searing, carmelization, etc. In some embodiments, units emitting at higher frequencies around 2450 MHz can be disposed toward the end of the main electromagnetic wave heating chamber. In some embodiments, other types of heating units that may be useful in browning or similar processes, such as infrared heating units, can be preferentially disposed toward the end of the main electromagnetic wave heating chamber.

While in many embodiments the system can include the application of microwave energy, in other embodiments, energy can be applied from another portion of the electromagnetic spectrum, either by itself or in combination with other wavelengths of electromagnetic radiation. For example, in various embodiments herein, the application of electromagnetic energy with a frequency of between 13.56 MHz to 300 MHz can be included. It will be appreciated that references herein to chambers of the apparatus, emitters, and other components that specifically reference microwaves are also applicable in the context of the application of electromagnetic radiation with a frequency of between about 13.56 MHz to about 300 MHz.

In general, microwave energy at lower frequencies (e.g., around 915 MHz) penetrate into food products more deeply than microwave energy at a higher frequency (e.g., around 2450 MHz). In some embodiments, emitters that provide microwave energy at frequencies that penetrate less (e.g., higher frequencies) can be arranged toward the downstream side of the main electromagnetic wave heating chamber 204 and thus closer in both proximity and time to the cool-down chamber 206. Similarly, emitters that provide electromagnetic wave energy at frequencies that penetrate more (e.g., lower frequencies) can be arranged toward the upstream side of the main electromagnetic wave heating chamber 204 to accommodate the placement of the other emitters.

While the electromagnetic wave units 213 in FIG. 2 are shown arranged on the top of the main electromagnetic wave heating chamber 204, it will be appreciated that the electromagnetic wave units 213, or at least a portion of them such as a waveguide, horn, waveguide cover, or the like can be arranged on any of the top, bottom, or sides of the main electromagnetic wave heating chamber 204. In some embodiments the electromagnetic wave units 213 are arranged opposed from one another on opposite sides of the main electromagnetic wave heating chamber 204. In some embodiments, electromagnetic wave units 213 can be arranged in an offset or staggered pattern.

The electromagnetic wave units 213 and/or the system can be configured to deliver electromagnetic wave radiation to the food packages multidirectionally or unidirectionally. In many embodiments, the electromagnetic wave units 213 and/or the system can be configured to deliver electromagnetic wave radiation to the food packages unidirectionally. As such, in embodiments providing electromagnetic wave radiation unidirectionally, the system herein stands in contrast to many consumer microwave ovens wherein microwave radiation bounces off walls and may therefore hit an item to be heated from many different angles simultaneously. In various embodiments, stray electromagnetic wave radiation can be absorbed by the fluid in the system surrounding the food products. In some embodiments, the interior of one or more chambers of the system can be lined with a material that absorbs electromagnetic wave radiation instead of reflecting it.

Food products 210 can be moved by the product conveyor mechanism 208 from the main electromagnetic wave heating chamber 204 and into a following chamber such as the cool-down chamber 206. It will be appreciated, however, that in some embodiments food products may enter a holding chamber before entering the cool down chamber 206.

The cool-down chamber 206 can also be oriented for vertical product movement. In specific, the cool-down chamber 206 can be oriented for vertical movement of food products 210 (or a flight of food products) along a product conveyor mechanism 208 through the continuous processing channel 201 of the processing system 200 in the direction of arrows 203. In some embodiments, an actuator or similar mechanism can be disposed within the cool-down chamber 206 in order to cause rotation (such as axial rotation) of the food products.

The cool-down chamber 206 can also include a fluid column 209. In this case, the fluid column 209 is in fluid communication with the main electromagnetic wave heating chamber 204. The fluid column 209 exerts a force downward onto the fluid in the main electromagnetic wave heating chamber 204 such that the pressure in the main electromagnetic wave heating chamber 204 is higher than in the area above the fluid column 209 (for example, in many cases above atmospheric pressure). In some embodiments, the maximum pressure within the cool-down chamber 206 is from about 0 psig to about 60 psig. In various embodiments, the temperature of the fluid in the cool-down chamber 206 can be from about 32 degrees Fahrenheit to about 300 degrees Fahrenheit. The final temperature of food products exiting the system can vary, but in some embodiments the final temperature (exit temperature) can be from about 32 degrees to about 212 degrees. In some embodiments the final temperature (exit temperature) can be from about 80 degrees to about 150 degrees.

In some embodiments, the cool-down chamber 206 can be substantially air-tight except for the area where food products enter the cool-down chamber 206 and the area where food products exit the cool-down chamber 206. In some embodiments, access hatches or ports (including but not limited to fluid exchange ports) and/or observation windows can be included at various points along the path of the cool-down chamber 206.

The height of the cool-down chamber 206 can vary. In general, the taller the cool-down chamber is, the taller the water column(s) therein can be. As such, the height can vary depending on the desired water column height which in turn can vary based on desired pressures. However, in some embodiments the height of the cool-down chamber can be greater than about 2, 4, 6, 8, 10, 15, 20, 25, 30, 40, 50, 60, 70, or 100 feet. In some embodiments, the height of the cool-down chamber can be in a range wherein each of the foregoing numbers can serve as the lower or upper bound of the range provided that the upper bound is higher than the lower bound.

In some embodiments the height of one or more water columns in the cool-down chamber can be greater than about 1, 3, 5, 7, 9, 14, 19, 24, 29, 39, 49, 59, 69, or 99 feet. In some embodiments, the height of one or more water columns in the cool-down chamber can be in a range wherein each of the foregoing numbers can serve as the lower or upper bound of the range provided that the upper bound is higher than the lower bound.

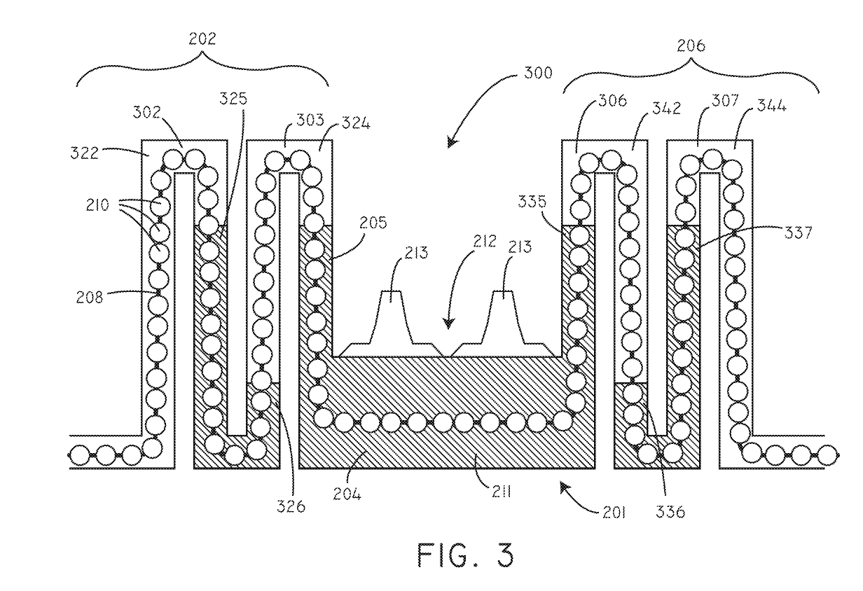

The pressure that can be provided by a single column of a fluid is typically limited by the height of the column of fluid. However, columns can be arranged in series with one another in order to reach higher pressures for a given limitation on total height. In some cases, additional legs of a portion of the system (come-up, cool-down, etc.) providing additional fluid columns to achieve higher (or lower) pressures can be referred to as over-pressure chambers. Referring now to FIG. 3, a schematic side view of a processing system 300 in accordance with various embodiments herein is shown illustrating the use of multiple columns of fluid. The processing system 300 includes a continuous processing channel 201. The continuous processing channel 201 can include a come-up chamber or zone 202, a main electromagnetic wave heating chamber or zone 204, and a cool-down chamber or zone 206. The main electromagnetic wave heating chamber or zone 204 can be filled with a fluid 211. The processing system 200 can also include an electromagnetic wave energy emitting apparatus 212.

The come-up chamber 202 can include a first leg 302 and a second leg 303. The first leg 302 includes a first upstream (e.g., upstream from the main electromagnetic wave heating chamber 204) column of fluid 325 in fluid communication with a second upstream column of fluid 326. In this case, the height of the first upstream column of fluid 325 is higher than the height of the second upstream column of fluid 326 and thus at steady-state the pressure inside the head space 324 of the second leg 303 is higher than inside the head space 322 of the first leg 302. The pressure inside the head space 324 of the second leg 303 effectively adds to the amount of force that is exerted downward by the third upstream column of fluid 327. As such, the pressure in the main electromagnetic wave heating chamber 204 is higher than would otherwise be attained by the third upstream column of fluid 327 alone.

The cool-down chamber 206 can include a first leg 306 and a second leg 307. The first leg 306 includes a first downstream (e.g., downstream from the main electromagnetic wave heating chamber 204) column of fluid 335 in fluid communication with a second downstream column of fluid 336. The second leg 307 includes a third downstream column of fluid 337. In this case, because of the forces exerted by the columns of fluid, the pressure inside the head space 342 of the first leg 306 is higher than inside the head space 344 of the second leg 307.

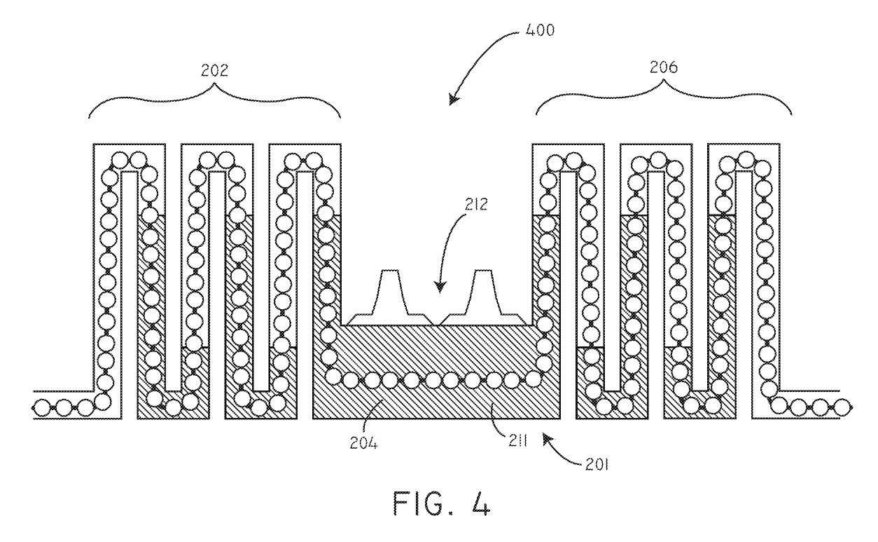

It will be appreciated that additional legs can be added to one or both of the upstream and downstream sides of the electromagnetic wave heat chamber in order to achieve greater or lesser pressures. Referring now to FIG. 4, a schematic side view of a processing system 400 in accordance with various embodiments herein is shown. The processing system 400 includes a continuous processing channel 201. The continuous processing channel 201 can include a come-up chamber or zone 202, a main electromagnetic wave heating chamber or zone 204, and a cool-down chamber or zone 206. The system 400 can also include an electromagnetic wave energy emitting apparatus 212. The main electromagnetic wave heating chamber or zone 204 can be filled with a fluid 211.

In this example, the come-up chamber 202 can include three legs. Similarly, the cool-down chamber can also include three legs. While these examples show equal numbers of upstream and downstream legs, it will be appreciated that the system can also be designed with unequal number of legs between the upstream and downstream sides.

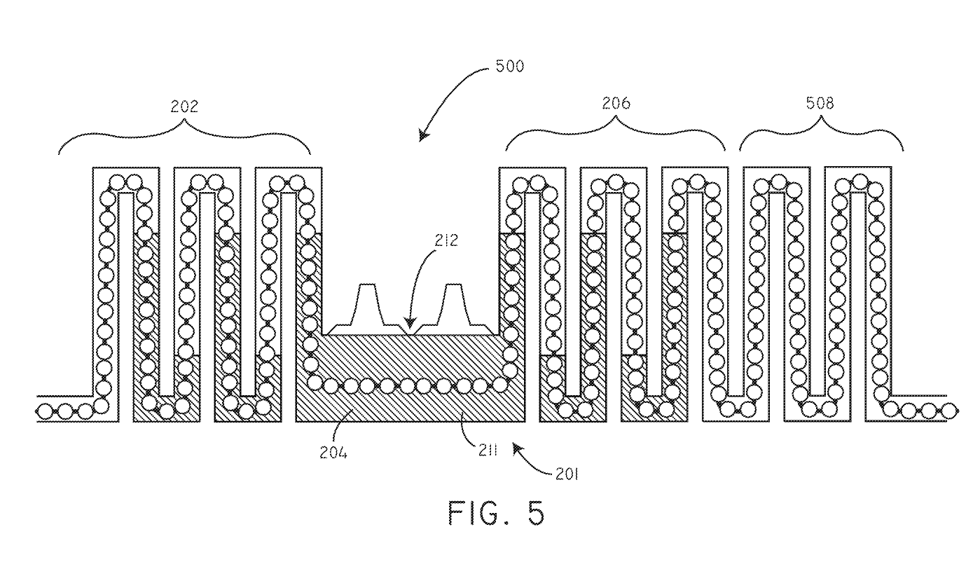

In some embodiments, the processing system can also include other components along the continuous processing channel. By way of example, the processing system can also include an air-filled cooling chamber (at atmospheric pressure or a different pressure). Referring now to FIG. 5, a schematic side view of a processing system 500 in accordance with various embodiments herein is shown. The processing system 400 includes a continuous processing channel 201. The continuous processing channel 201 can include a come-up chamber or zone 202, a main electromagnetic wave heating chamber or zone 204, and a cool-down chamber or zone 206. The system 400 can also include an electromagnetic wave energy emitting apparatus 212. The main electromagnetic wave heating chamber or zone 204 can be filled with a fluid 211. In this case, the system 400 can also include an air-filled cooling chamber 508 (or cooling tower) to receive food products from the cool-down chamber 206. While in this embodiment the air-filled cooling chamber 508 is shown directly connected to the cool-down chamber 206, in some embodiments there can be other components disposed in between.

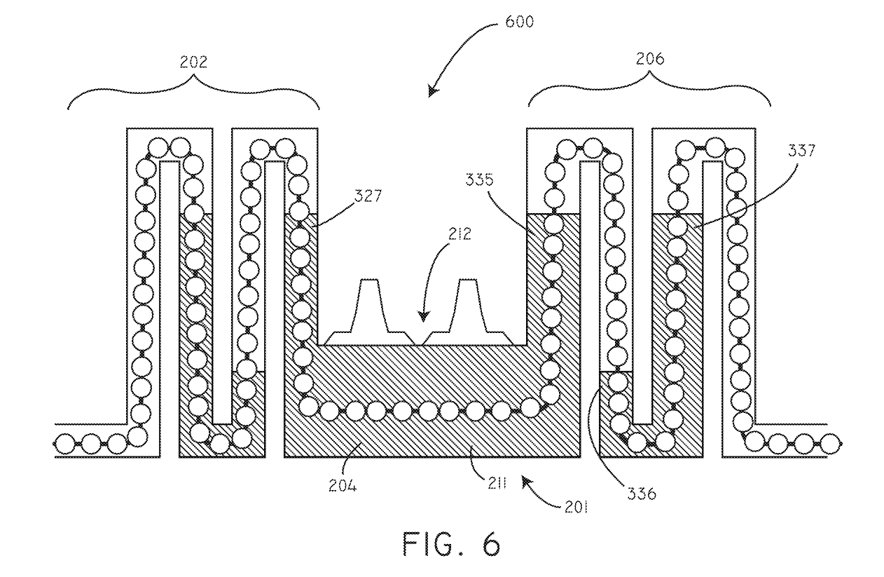

In some embodiments, the horizontal dimensions of fluid columns in the system can all be the same. In other embodiments, different fluid columns can have different horizontal dimensions. As such, the fluid columns (even those in direct contact with one another) can be asymmetric. Referring now to FIG. 6, a schematic side view of a processing system 600 in accordance with various embodiments herein is shown. The processing system 600 includes a continuous processing channel 201. The continuous processing channel 201 can include a come-up chamber or zone 202, a main electromagnetic wave heating chamber or zone 204, and a cool-down chamber or zone 206. The main electromagnetic wave heating chamber or zone 204 can be filled with a fluid 211. The system 600 can also include an electromagnetic wave energy emitting apparatus 212. The third upstream fluid column 327 can have a first width and the first downstream fluid column 335 can have a second width that is different than the first width. As such, based on the principle of fluid displacement, a given amount of vertical movement of the top of the third upstream fluid column 327 will result in a smaller amount of vertical movement of the top of the first downstream fluid column 335. Similarly, the second downstream fluid column 336 can have a third width and the third downstream fluid column 337 can have a fourth width that is different than the third width.

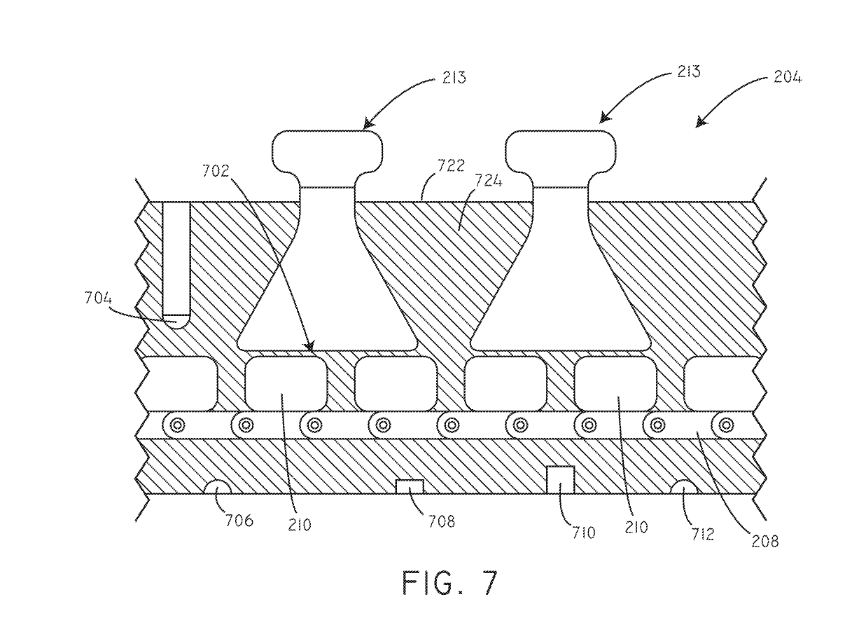

Referring now to FIG. 7, a schematic side view of a portion of a main electromagnetic wave heating chamber 204 in accordance with various embodiments herein is shown. The main electromagnetic wave heating chamber 204 can include a housing 722 defining an interior volume 724. In various embodiments, the interior volume 724 can be filled, and in some cases completely filled, with a fluid 211. The main electromagnetic wave heating chamber 204 can include one or more electromagnetic wave units 213. The electromagnetic wave units 213 can be oriented so as to deliver electromagnetic wave energy to food products or flights of food products 210 that are moved through the main electromagnetic wave heating chamber 204 via a product conveyor mechanism 208.

Various components can be disposed within or adjacent to the main electromagnetic wave heating chamber. By way of example, the main electromagnetic wave heating chamber 204 can include various sensors. As a specific example, the main electromagnetic wave heating chamber 204 can include a proximity or distance sensor 704. The proximity or distance sensor 704 can be used to detect the distance to the food products or flights of food products 210. In some cases, this information can be used to regulate the dose of electromagnetic wave energy delivered to the food products or flights of food products 210. In some cases, this information can be used to determine the presence of the food products or flights of food products 210. In some embodiments, a plurality of proximity or distance sensors can be included. In some embodiments the plurality of proximity or distance sensors can be connected to or otherwise associated with one or more electromagnetic wave units or components thereof such as emitters, waveguides, horns, waveguide covers, etc.

In some embodiments, the main electromagnetic wave heating chamber 204 can also include one or more of a temperature sensor 706, a pressure sensor 708, an electromagnetic wave energy detector 710, and a sensor or sensor package to detect fluid status (such as pH, total dissolved solids, total suspended solids) or the like. Various other sensors can also be included such as, but not limited to, a deflection sensor, an infrared sensor, an optical sensor, a rotation sensor or the like.

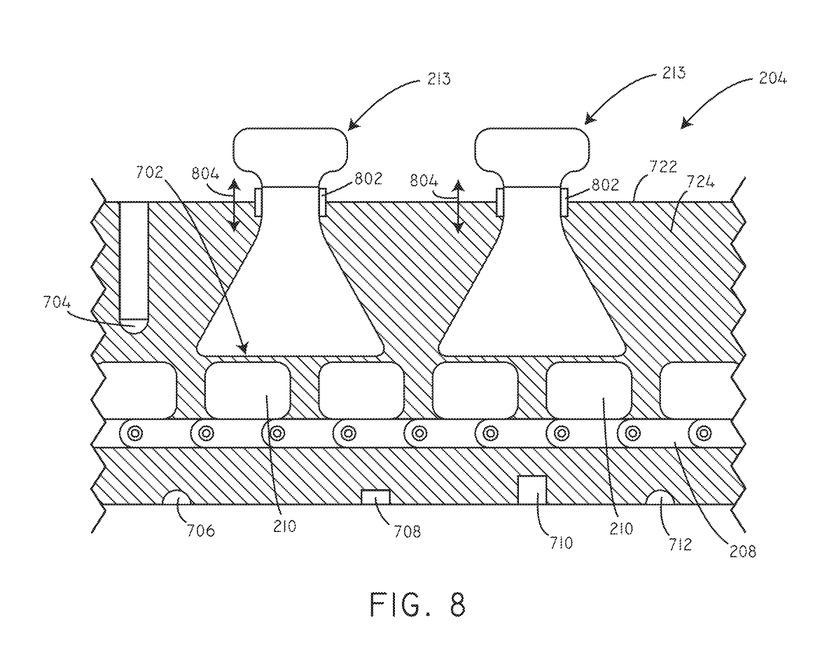

If the fluid includes polar compounds (such as water) an amount of electromagnetic wave energy will be absorbed the fluid itself. As such, the intensity of the electromagnetic wave energy will be attenuated as it travels through the fluid. As such, the distance between the food product and the place where the electromagnetic wave energy first enters the fluid (such as the nearest portion of electromagnetic wave units 213) is one variable that can be regulated in order to achieve a desirable level of consistency. In some embodiments, the electromagnetic wave units 213 or a portion thereof can be moved in order to achieve a high level of consistency of distance the electromagnetic wave energy must travel through fluid before entering the food product. Referring now to FIG. 8, a schematic side view of a main electromagnetic wave heating chamber in accordance with various embodiments herein is shown. The main electromagnetic wave heating chamber 204 can include a housing 722 defining an interior volume 724. In various embodiments, the interior volume 724 can be filled, and in some cases completely filled, with a fluid 211. The main electromagnetic wave heating chamber 204 can include one or more electromagnetic wave units 213. The electromagnetic wave units 213 can be oriented so as to deliver electromagnetic wave energy to food products or flights of food products 210 that are moved through the main electromagnetic wave heating chamber 204 via a product conveyor mechanism 208. Actuators 802 can be included that can cause movement of the electromagnetic wave units 213 in the direction of arrows 804. As such, if a proximity or distance sensor 704 indicates a change in the distance of the food products relative to the electromagnetic wave units 213 then the position of the electromagnetic wave units 213 (or a distal portion thereof such as a distal portion of the waveguide) can be adjusted so as to maintain a desired distance that the electromagnetic wave energy must travel through the fluid before entering the food product being processed. In another scenario, if the food products vary in size, as indicated by a sensor or through user input, then the position of the electromagnetic wave units 213 can be adjusted so as to result in a greater or lesser amount of electromagnetic wave energy entering the food product being processed. In some embodiments, the system can be configured so as to allow movement of a plurality of electromagnetic wave units, or a component thereof, in synchrony with the movement of other electromagnetic wave units. By way of example, the system can be configured to accept a command from a user or system subcomponent that can cause the movement of multiple electromagnetic wave units.

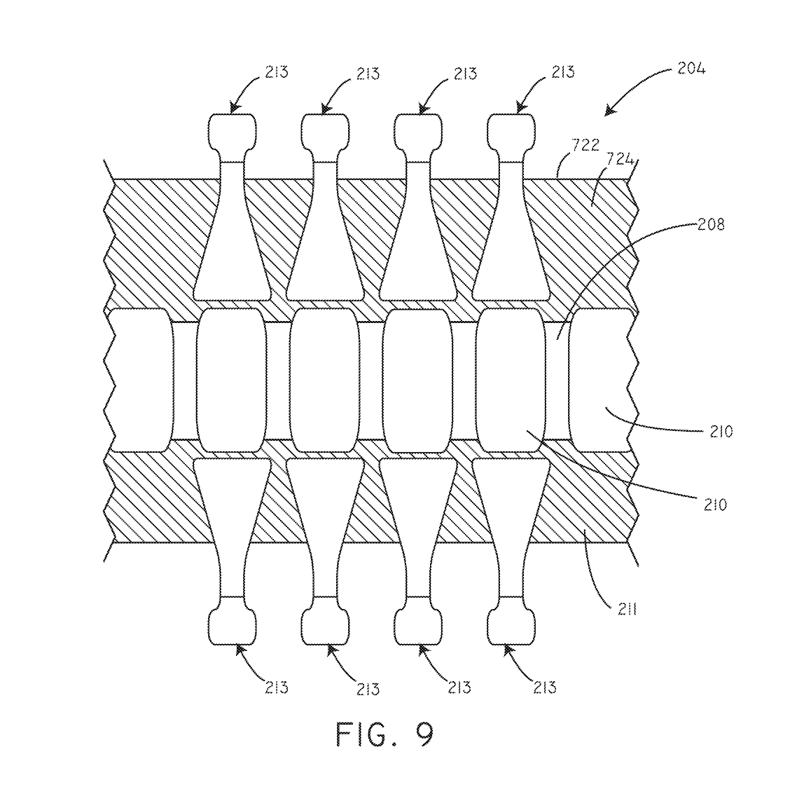

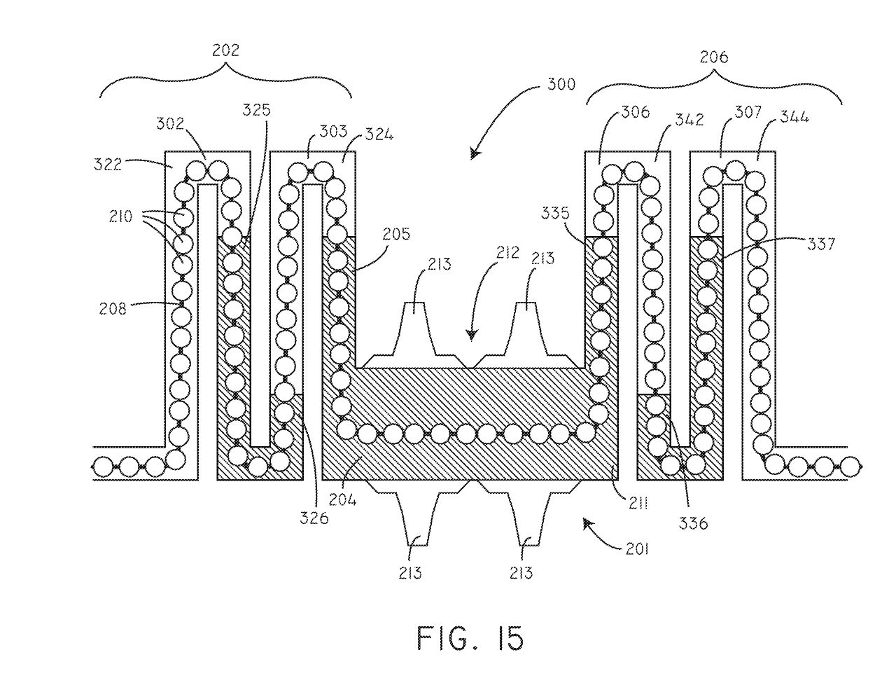

Referring now to FIG. 9, a top view of a main electromagnetic wave heating chamber 204 in accordance with various embodiments herein is shown. The main electromagnetic wave heating chamber 204 can include a housing 722 defining an interior volume 724. In various embodiments, the interior volume 724 can be filled, and in some cases completely filled, with a fluid 211. The main electromagnetic wave heating chamber 204 can include food products or flights of food products 210 attached to a product conveyor mechanism 208. The main electromagnetic wave heating chamber 204 can include electromagnetic wave units 213 to deliver electromagnetic wave energy to the food products or flights of food products 210. In this case, the electromagnetic wave units 213 are oriented on the sides of the main electromagnetic wave heating chamber 204 and opposed to one another. However, as stated previously, the electromagnetic wave units 213 (or portions thereof) can be disposed on any of the top, bottom or sides of the main electromagnetic wave heating chamber 204. By way of example, in some embodiments the electromagnetic wave units 213 can be opposed on the top and bottom of the electromagnetic wave heating chamber. Referring now to FIG. 15, a schematic side view of a processing system is shown in accordance with various embodiments herein where the electromagnetic wave units 213 are disposed in opposition on the top and bottom of the electromagnetic wave heating chamber 204 (wherein the reference numbers in FIG. 15 correspond to the same components as described with respect to FIG. 3 discussed above).

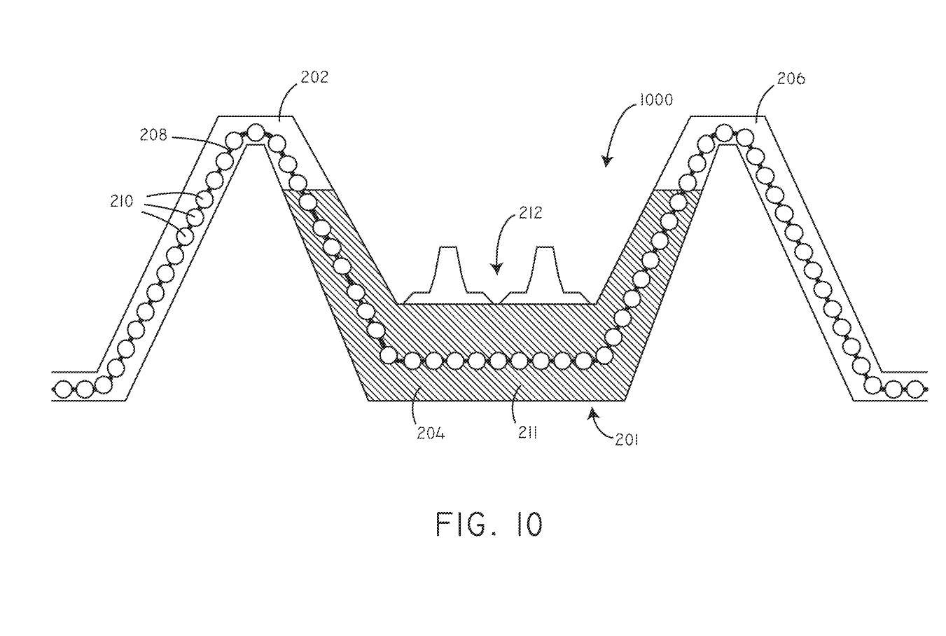

It will be appreciated that references herein to passing food products vertically through a fluid column (upward or downward) does not require that such movement be purely vertical and that simultaneous horizontal movement can also occur unless stated otherwise. Referring now to FIG. 10 is a schematic side view of a processing system 1000 in accordance with various embodiments herein is shown. The processing system 1000 includes a continuous processing channel 201. The continuous processing channel 201 can include a come-up chamber or zone 202, a main electromagnetic wave heating chamber or zone 204, and a cool-down chamber or zone 206. The come-up chamber 202 can be oriented for vertical product movement. In specific, the come-up chamber 202 can be oriented for vertical movement of food products 210 (or flights of food products) along a product conveyor mechanism 208 through the continuous processing channel 201 of the processing system 1000. In this embodiment, some portions of the system are angled such that vertical movement is also accompanied by horizontal movement. Food products 210 can be moved by the product conveyor mechanism 208 from the come-up chamber 202 and into the main electromagnetic wave heating chamber 204. The main electromagnetic wave heating chamber 204 can be filled with a fluid 211. Food products 210 can then be moved by the product conveyor mechanism 208 from the main electromagnetic wave heating chamber 204 to the cool-down chamber 206.

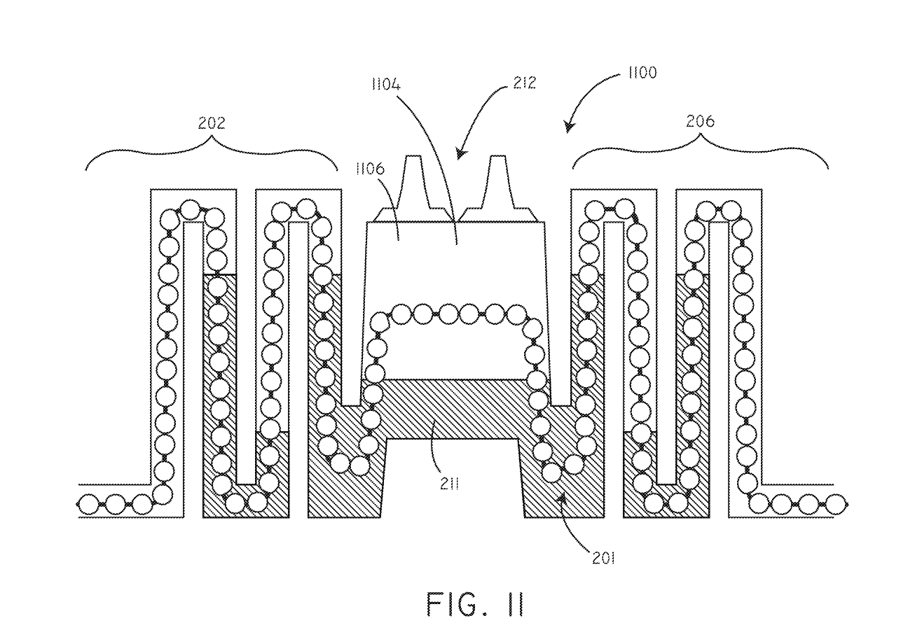

In some embodiments, the main electromagnetic wave heating chamber or zone may be only partially filled with a fluid. For example, a portion of the main electromagnetic wave heating chamber can be filled with a fluid and a portion can be filled with a non-fluid, such as steam. Referring now to FIG. 11, a schematic side view of a processing system 1100 in accordance with various embodiments herein is shown. The processing system 1100 includes a continuous processing channel 201. The continuous processing channel 201 can include a come-up chamber or zone 202, a main electromagnetic wave heating chamber or zone 1104, and a cool-down chamber or zone 206. The system 400 can also include an electromagnetic wave energy emitting apparatus 212. The main electromagnetic wave heating chamber or zone 1104 can be partially filled with a fluid 211. The main electromagnetic wave heating chamber or zone 1104 can also include a portion 1106 that is not filled with a fluid. This portion 1106 can be filled with steam in some embodiments. In this embodiment, the food products or flights of food products can move upward within the main electromagnetic wave heating chamber as they pass through. In other embodiments (such as other embodiments shown with reference to other figures) the food products or flights of food products can move horizontally through the main electromagnetic wave heating chamber without substantial vertical movement.

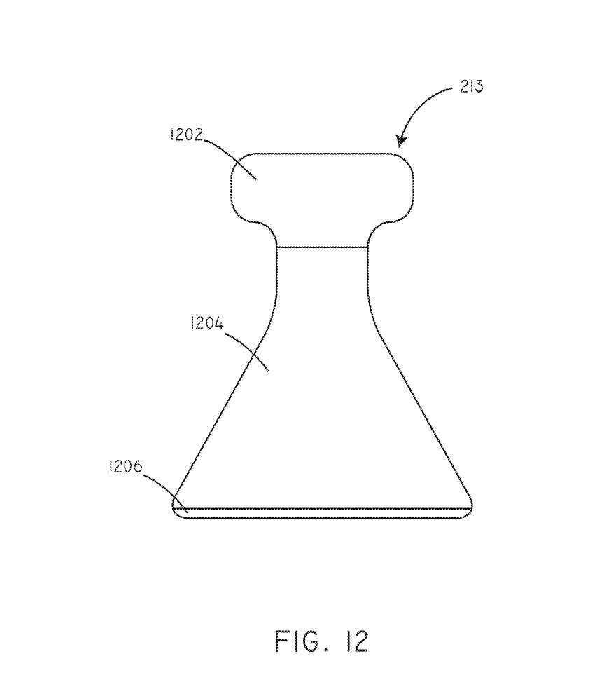

Referring now to FIG. 12, a schematic side-view of an electromagnetic wave unit 213 is shown in accordance with various embodiments herein. The electromagnetic wave unit 213 can include an electromagnetic wave generation segment 1202. The electromagnetic wave generation segment 1202 can include components to generate electromagnetic waves such as a magnetron, RF power transistor, or similar electromagnetic wave emitting device. As an example of an RF power transistor, a laterally-diffused metal oxide semiconductor field-effect transistor (LDMOS-FET) can be used to generate electromagnetic wave energy. The electromagnetic wave unit 213 can also include a waveguide 1204. In some cases at least a portion of the waveguide 1204 can be referred to as a horn. In some embodiments, the waveguide 1204 can define an interior volume or channel comprising a distal end, the distal end of the channel hermetically sealed with a waveguide cover 1206 or window. The covers/windows may be single or may include multiple windows permanently mounted or adjusted to accommodate the electromagnetic wave dampening effect as desired for the process. In some embodiments the interior volume or channel can be curved. In some embodiments the interior volume can be fluted (e.g., with interior baffles to facilitate appropriate carry of the wave to the target). In some embodiments, the interior volume defined by the waveguide 1204 can be a vacuum. In some embodiments, the interior volume defined by the waveguide 1204 can be filled with air. In some embodiments, the interior volume defined by the waveguide 1204 can be filled with a fluid that is substantially transparent to electromagnetic wave energy, such as a nonpolar fluid. It will be appreciated that while FIG. 12 shows a one to one relationship between the wave generation segment (or generator such as a magnetron) in other embodiments multiple waveguides 1204 and/or waveguide covers 1206 can share a single generator or magnetron.

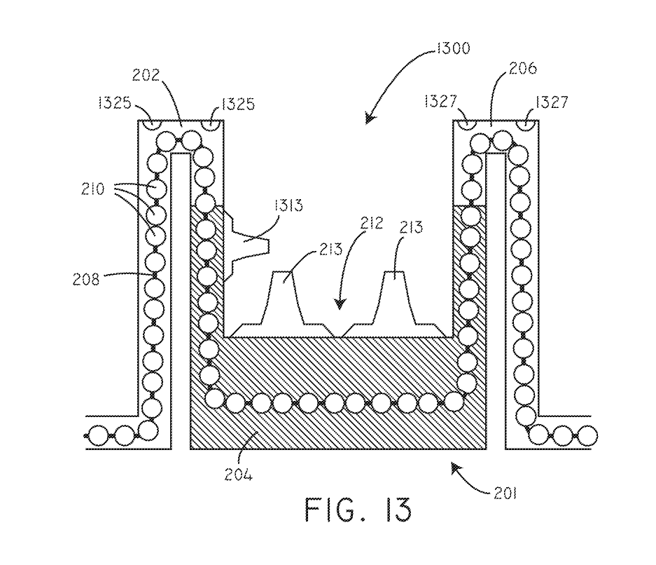

In various embodiments, electromagnetic wave units can be disposed in or on portions of the system other than the main electromagnetic wave heating chamber. By way of example, in some embodiments, electromagnetic wave units can be disposed in or on the come-up chamber. Referring now to FIG. 13, a schematic side view is shown of a processing system 1300 in accordance with various embodiments herein. The processing system 1300 includes a continuous processing channel 201. The continuous processing channel 201 can include a come-up chamber or zone 202, a main electromagnetic wave heating chamber or zone 204, and a cool-down chamber or zone 206. The system 1300 can also include an electromagnetic wave energy emitting apparatus 212 including electromagnetic wave units 213. Food products 210 (or flights of food products) can be moved along a continuous processing channel 201 by a product conveyor mechanism 208. In this example, the come-up chamber 202 can also include one or more electromagnetic wave units 1313. In addition, in some embodiments, the system 1300 can include one or more sensors 1325 (which can be of any type previously mentioned) in the come-up chamber 202. In addition, in some embodiments, the system 1300 can include one or more sensors 1327 (which can be of any type previously mentioned) in the cool-down chamber 206. Such sensors can, in some cases, be in addition to sensors in the main electromagnetic wave heating chamber 204.

In some embodiments, the system can include containment devices such as baffles, deflectors, shielding, or the like to control where electromagnetic wave energy travels. In some embodiments, the containment devices can be moveable in order to facilitate the optimization of processing of particular food package sizes, shapes, etc. For example, containment devices can be operatively connected to one or more actuators (hydraulic, pneumatic, electric, or the like) in order to cause them to move.

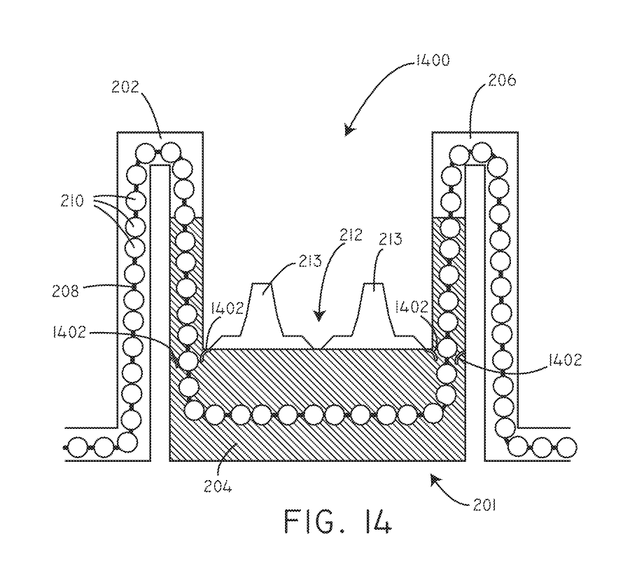

Referring now to FIG. 14, a schematic side view is shown of a processing system 1400 in accordance with various embodiments herein. The processing system 1400 includes a continuous processing channel 201. The continuous processing channel 201 can include a come-up chamber or zone 202, a main electromagnetic wave heating chamber or zone 204, and a cool-down chamber or zone 206. The system 1400 can also include an electromagnetic wave energy emitting apparatus 212 including electromagnetic wave units 213. Food products 210 (or flights of food products) can be moved along a continuous processing channel 201 by a product conveyor mechanism 208. In this example, the system 1400 can also include containment devices 1402. The containment devices 1402 can be flexible or rigid. The containment devices 1402 can be made of materials that absorb electromagnetic wave energy and/or reflect electromagnetic wave energy. The containment device 1402 can be shaped and positioned so that electromagnetic wave energy stays in certain areas of the system 1400. By way of example, in some embodiments the containment devices can be shaped and/or positioned so as to keep electromagnetic wave energy within the main electromagnetic wave heating chamber 204.

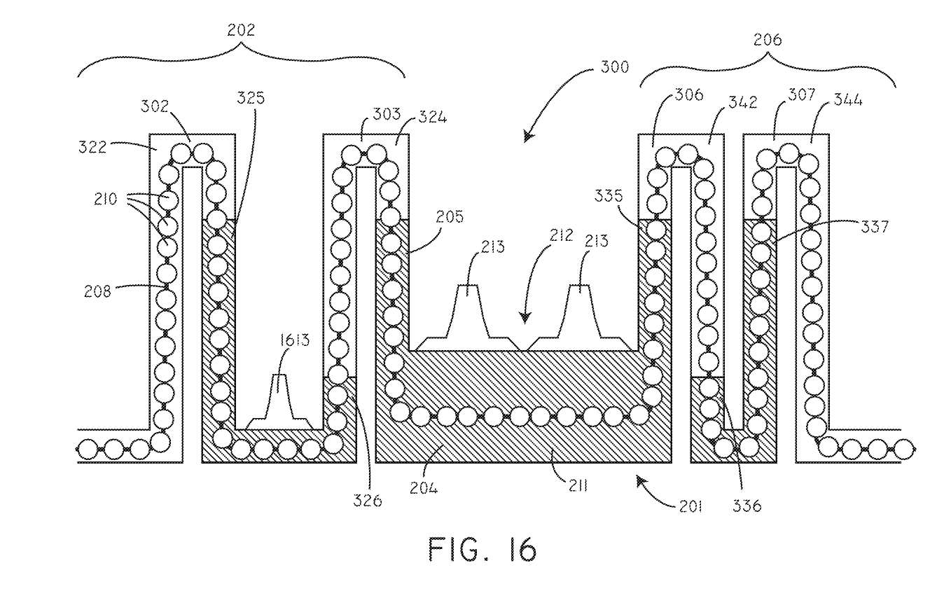

It will be appreciated that in some embodiments that electromagnetic wave or other electromagnetic wave energy can also be applied outside of the main heating chamber, such as in the come-up chamber or zone as a preheating mechanism. Referring now to FIG. 16 a schematic side view of a processing system is shown in accordance with various embodiments herein. In this view an electromagnetic wave (such as electromagnetic wave) emitting unit 1613 can be positioned in the come-up chamber or zone 202 (the remaining reference numbers shown in FIG. 16 correspond to the same components as described with respect to FIG. 3 discussed above).

The housings used to form the various portions of the system described herein can be made of various materials including, but not limited to, metals, polymers, ceramics, composites, or the like. In some embodiments, the housings of at least some portions of the system herein are formed from stainless steel.

In addition to the different type of chambers described above, it will be appreciated that the system can also include other types of chamber or more than one of any of the types of chambers described above. By way of example, in some embodiments, the system can also include one or more holding chambers. Holding chamber(s) can be positioned in front of or behind of any of the other chambers of the system.

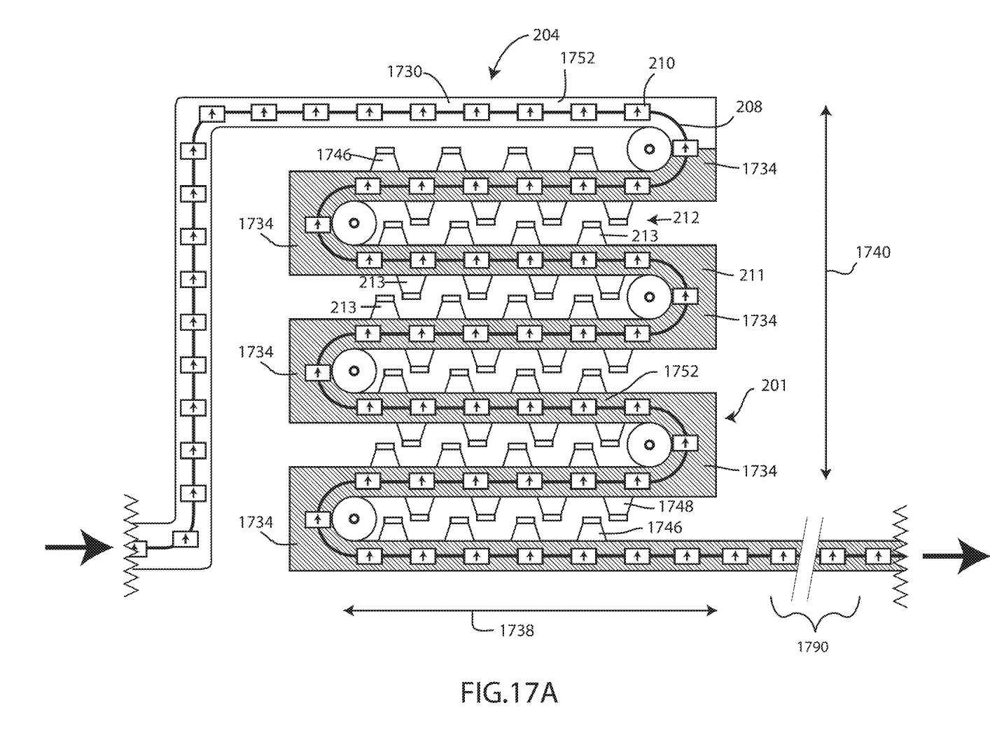

Referring now to FIG. 17A, a schematic side view is shown of a portion of a processing system in accordance with various embodiments herein. The portion showing in FIG. 17A can serve as a heating chamber 204 or main heating chamber as referred to with regard to previous embodiments herein. As such, it will be understood that any of the other types of chambers, zones, equipment, etc. previously described herein can be used in combination with the portion of the processing system shown in FIG. 17A. For example, the processing system can also include a come-up chamber or zone (typically upstream from the heating chamber 204), a cool-down chamber or zone (typically downstream from the heating chamber 204), one or more holding chambers or zones, and the like. The electromagnetic wave heating chamber 204 can be configured to be at least partially filled with a fluid, and in particular, a fluid 211.

The system can also include an electromagnetic wave energy emitting apparatus 212 including electromagnetic wave units 213. Food products 210 (or flights of food products) can be moved along a continuous processing channel 201 by a product conveyor mechanism 208. The product conveyor mechanism 208 can be configured to convey food products 210 to be processed continuously along a conveyance path 1730 passing through the electromagnetic wave heating chamber 204.

The conveyance path 1730 can extend along the continuous processing channel 201. The conveyance path 1730 can include a serpentine pathway. The serpentine pathway can include a plurality of hairpin corners 1734 where a horizontal direction of the conveyance path 1730 is reversed and a depth of the conveyance path 1730 is increased.

In some embodiments, the serpentine pathway can include 1, 2, 3, 4, 5, 6, 7, 8, 9, 10, 11, 12, 13, 14, 15, 16, 17, 18, 19 or 20 hairpins turns. In some embodiments, the serpentine pathway can include a number of hairpin turns falling within a range wherein any of the foregoing numbers can serve as the upper or lower bound of the range. In some embodiments, the hairpin turns can reflect a change in the direction of the pathway of at least about 90, 100, 110, 120, 130, 140, 150, 160, 170, or 180 degrees. In some embodiments, the hairpin turns can reflect a change in a direction that falls within a range between any of the foregoing angles.

In some embodiments, the hairpin turns (as measured with reference to the conveyance path) can have a radius of curvature of about 2, 4, 6, 8, 10, 12, 14, 16, 18, 20, 25, 30, 40, 50, 60, 70 or 80 inches.

The horizontal direction of the conveyance path 1730 is represented by axis 1738. The depth of the conveyance path 1730 is represented by axis 1740. The average pressure in the electromagnetic wave heating chamber 204 can change or vary along the path of the conveyor mechanism 208. In some embodiments, the average pressure in the electromagnetic wave heating chamber 204 increases as the depth of the conveyance path 1730 increases.

The electromagnetic wave emitting apparatus 212 can be configured to emit electromagnetic energy into the conveyance path 1730. The electromagnetic wave emitting apparatus 212 can include a plurality of electromagnetic wave emitting units or emitters 213. The emitters 213 can be configured to emit energy into the conveyance path 1730. In some embodiments, the emitters 213 can include microwave emitters or radiofrequency (“RF”) wave emitters.

In various embodiments, the plurality of wave emitting units 213 can include a series of top wave emitting units 1746 and/or a series of bottom wave emitting units 1748. The series of top wave emitting units 1746 can be located above or on top of a portion of the conveyance path 1730. The series of top wave emitting units 1746 can be configured to emit energy downward into the conveyance path 1730. The series of bottom wave emitting units 1748 can be located underneath or below a portion of the conveyance path 1730. The series of bottom wave emitting units 1748 can be configured to emit energy upward into the conveyance path 1730. While top wave emitting units and bottom wave emitting units are shown in FIG. 17A, it will be appreciated that in addition to or in replacement of top and bottom wave emitting units, side emitters can also be used.

The conveyance path 1730 can include hairpin corners 1734. The hairpin corners 1734 can be U-shaped or form a U-turn. The conveyance path 1730 can include a plurality of switchbacks such that the conveyance path 1730 turns around and extends in the opposite direction. The conveyance path 1730 can switch or reverse direction.

In many embodiments the conveyance path 1730 can include horizontal conveyance legs 1752. A horizontal conveyance leg 1752 can be disposed between each of the adjacent hairpin corners 1734 along the conveyance path 1730. In various embodiments, the horizontal conveyance legs 1752 can be parallel with the horizontal axis 1738. In some embodiments, the horizontal conveyance legs 1752 at an angle of less than 10 degrees with respect to horizontal. In some embodiments, the horizontal conveyance legs 1752 at an angle of less than 15 degrees with respect to horizontal.

As shown in FIG. 17A, the conveyance path 1730 leads into an optional hold chamber 1790 after exiting the electromagnetic wave heating chamber 204. A hold chamber (or section or zone) can be a segment with or without electromagnetic wave emitters and can be a fluid-filled chamber or a gas-filled (such as steam) chamber. Pressure and temperature can remain constant in a hold chamber, or can be influenced in a fluid system with a hydrostatic head pressure and/or with the assistance of overpressure.

It will be appreciated that the conveyance path 1730 of FIG. 17A may run through a single large vessel. For example, referring now to FIG. 17B, components like that shown in FIG. 17A are shown disposed in a single fluid-filled vessel. In such a case, the emitters can be attached to sides of the vessel but still emit upward or downward into the conveyance path or be mounted on support rods or the like.

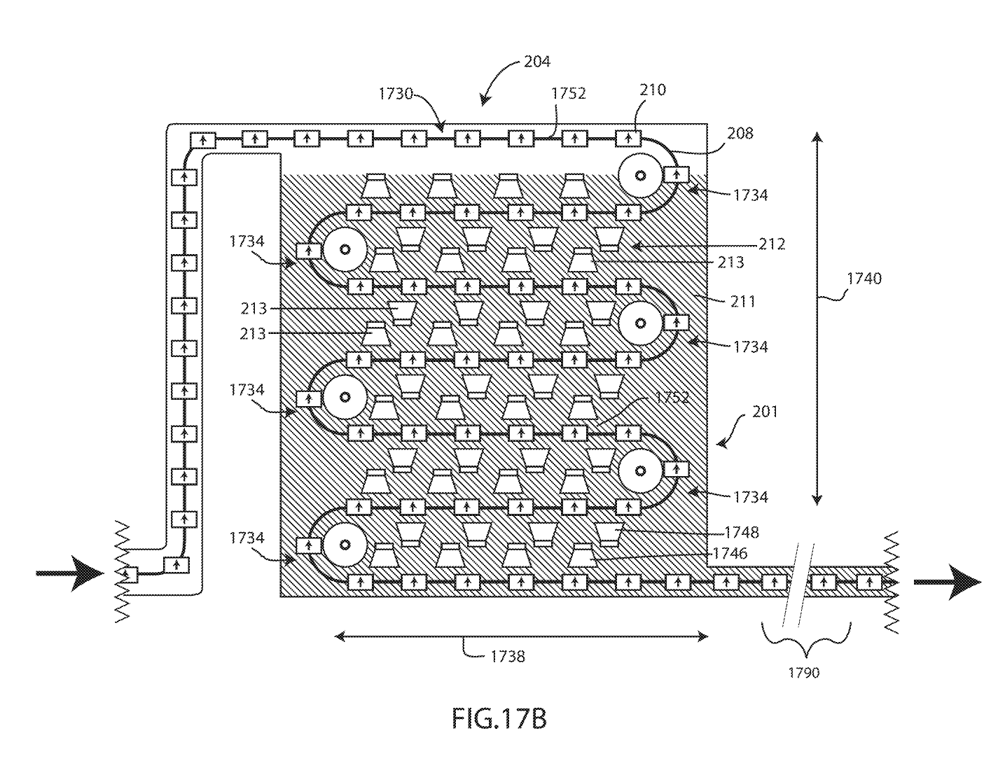

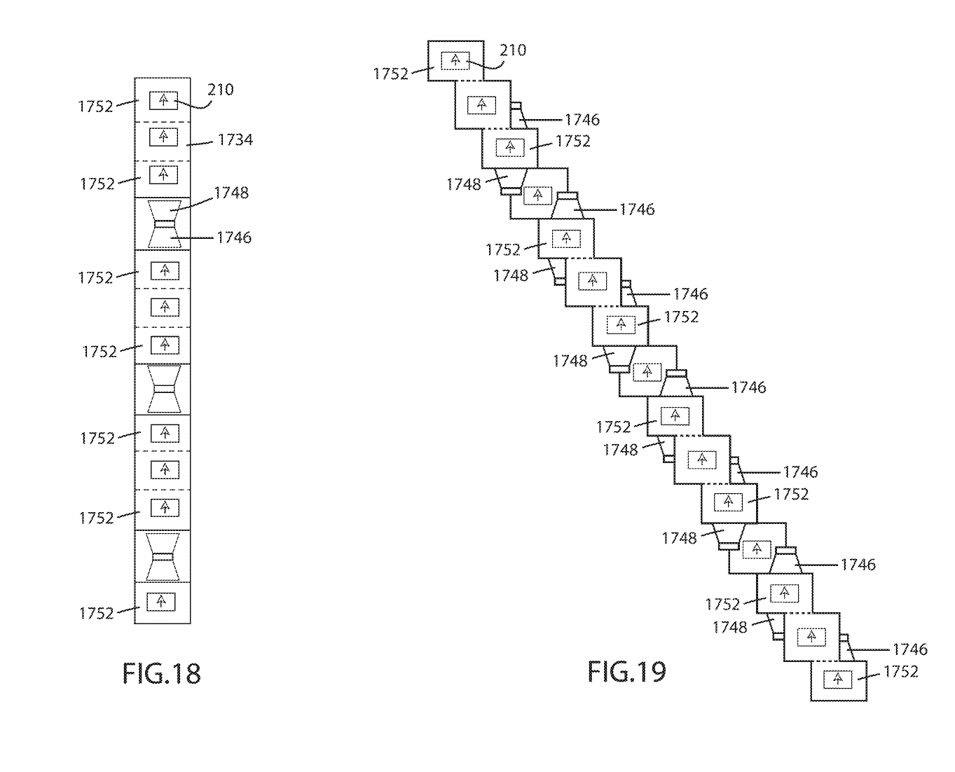

In various embodiments, the horizontal conveyance legs 1752 can be stacked vertically with respect to one another, such as shown in FIG. 18. In other embodiments, the horizontal conveyance legs 1752 can be offset horizontally with respect to one another, such as shown in FIG. 19. In some embodiments, at least some of the emitters 213 are disposed between adjacent stacked horizontal conveyance legs 1752.

In various embodiments, the system can be configured to ensure that the orientation of the food products with respect to the vertical and horizontal axes is substantially constant as the products move along the conveyance path 1730. For example, the system can be configured to prevent the food products from flipping over or substantially rotating with respect to the vertical and/or horizontal axes as they move along the conveyance path 1730. In some embodiments, orientation constancy can be maintained throughout the whole electromagnetic wave heating chamber 204. In other embodiments, orientation constancy is maintained throughout at least a portion (e.g., 50%, 75%, 90% or 95% of the distance travelled) of the electromagnetic wave heating chamber 204. In some embodiments, orientation constancy can be maintained throughout the entire system including, but not limited to, various chambers or zones that can form the system such as one or more come-up chambers or zones, one or more electromagnetic wave heating chambers, one or more cool-down chambers or zones, one or more hold chambers or zones, and the like.

In various embodiments, the conveyor mechanism 208 can include a paternoster mechanism at each hairpin corner 1734, such as to maintain a consistent orientation of the product 210 along the conveyance path 1730. The paternoster mechanism can ensure the food product 210 only rotates minimally (or no rotation at all) in relation to a vertical axis around a hairpin corner 1734.

In various embodiments, the conveyor mechanism 208 can include a mechanical track. The mechanical track can include an overhead track, such that at least a portion of the track is located above the food product 210. In some embodiments, the food product 210 (or a carrier in which the food product rides) can hang from the mechanical track. The coupling between the food product 210 and the mechanical track can allow for the food product 210 (or a carrier in which the food product rides) to rotate with regards to the mechanical track, such that the food product 210 can maintain its orientation with respect to vertical as the mechanical track varies with respect to vertical. In some embodiments, the food product 210 (or a carrier in which the food product rides) can be mounted in a fixed relationship with respect to the track.

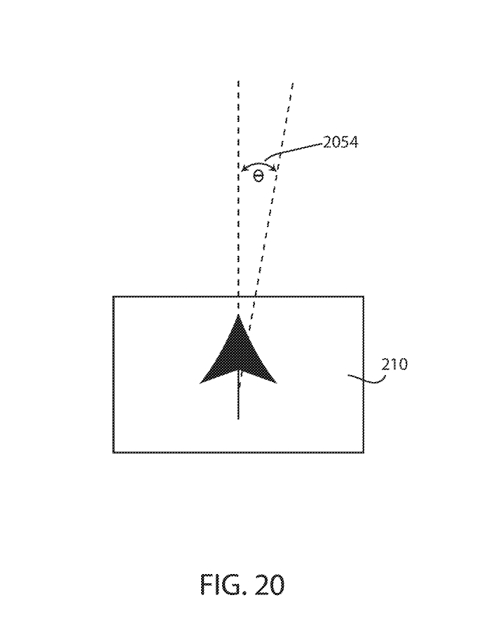

As referenced above, in various embodiments, the orientation of the products 210 carried along the conveyance path 1730 can remain constant. In some embodiments, the orientation of the products 210 carried along the conveyance path 1730 can vary by an angle 2054 defined by a vertical axis and a longitudinal axis of the product 210, such as shown in FIG. 20. In some embodiments, the orientation of the products 210 carried along the conveyance path 1730 varies by less than 15 degrees when passing through each hairpin corner 1734. In some embodiments, the orientation of the products 210 carried along the conveyance path 1730 varies by less than 10 degrees when passing through each hairpin corner 1734. In some embodiments, the orientation of the products 210 carried along the conveyance path 1730 varies by less than 5 degrees when passing through each hairpin corner 1734. In some embodiments, the orientation of the products 210 carried along the conveyance path 1730 varies by less than 2 degrees when passing through each hairpin corner 1734. In some embodiments, the orientation of the products 210 carried along the conveyance path 1730 varies by less than 1 degree when passing through each hairpin corner 1734.

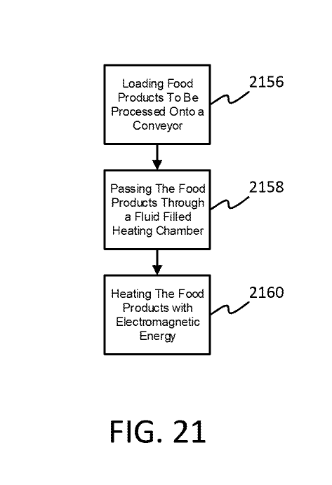

FIG. 21 shows a flow chart showing operations that can be performed in accordance with various embodiments herein. In an embodiment, a method for sterilizing food products can include loading food products to be processed onto a conveyor 2156. The method can further include passing the food products into a fluid filled main electromagnetic wave heating chamber by movement of the conveyor 2158.

The main electromagnetic wave heating chamber can define a conveyance path. The conveyance path can include a serpentine pathway. The serpentine pathway can include a plurality of hairpin corners where the horizontal direction of the conveyance path is reversed and the depth of the conveyance path is increased.

The main electromagnetic wave heating chamber can also include an electromagnetic wave emitting apparatus. The electromagnetic wave emitting apparatus can be configured to emit electromagnetic energy into the serpentine pathway. The electromagnetic wave emitting apparatus can include a plurality of wave emitting units configured to emit energy into the conveyance path.

The method can further include heating the food products with electromagnetic wave energy from the emitters as the food products pass through the main electromagnetic wave heating chamber 2160.

As referenced above, the food products can also pass through one or more chambers or zones before entering the main electromagnetic wave heating chamber 2160. For example, in some embodiments, the food products can pass through one or more come-up chambers or zones before entering the main electromagnetic wave heating chamber 2160. In some embodiments, the food products can also pass through one or more chambers or zones after passing through the main electromagnetic wave heating chamber 2160. For example, in some embodiments, the food products can pass through one or more cool-down chambers or zones, hold chambers or zones, or the like, after passing through the main electromagnetic wave heating chamber 2160.

The embodiments described herein are not intended to be exhaustive or to limit the invention to the precise forms disclosed in the following detailed description. Rather, the embodiments are chosen and described so that others skilled in the art can appreciate and understand the principles and practices.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

Aspects have been described with reference to various specific and preferred embodiments and techniques. However, it should be understood that many variations and modifications may be made while remaining within the spirit and scope herein.

1. A food processing system comprising:
a housing defining a processing channel comprising an electromagnetic wave heating chamber;
wherein the electromagnetic wave heating chamber is configured to be at least partially filled with a fluid;
a product conveyor mechanism to convey food products to be processed continuously along a conveyance path passing through the electromagnetic wave heating chamber;
the conveyance path comprising a serpentine pathway, the serpentine pathway comprising a plurality of hairpin corners wherein a horizontal direction of the conveyance path is reversed and a depth of the conveyance path is increased;
an electromagnetic wave emitting apparatus configured to emit electromagnetic energy into the serpentine pathway, the electromagnetic wave emitting apparatus comprising one or more electromagnetic wave units;
wherein the average pressure in the electromagnetic wave heating chamber changes along the path of the conveyor mechanism;
wherein the orientation of products carried along the conveyance path varies by less than 15 degrees when passing through each hairpin corner.

2. The food processing system of claim 1, wherein each hairpin corner comprises a paternoster mechanism.

3. The food processing system of claim 1, wherein the orientation of products carried along the conveyance path varies by less than 5 degrees when passing through each hairpin corner.

4. The food processing system of claim 1, the electromagnetic wave units comprising microwave energy emitters.

5. (canceled)

6. The food processing system of claim 1, the electromagnetic wave units comprising a series of top wave emitting units configured to emit energy downward into the conveyance path and a series of bottom wave emitting units configured to emit energy upward into the conveyance path.

7. The food processing system of claim 1, further comprising horizontal conveyance legs disposed between adjacent hairpin corners along the conveyance path.

8. (canceled)

9. The food processing system of claim 1, wherein the conveyance path through the horizontal conveyance legs is at an angle of less than 5 degrees with respect to horizontal.

10. The food processing system of claim 7, wherein the horizontal conveyance legs are stacked vertically with respect to one another.

11. The food processing system of claim 10, wherein at least some of the electromagnetic wave units are disposed between adjacent stacked horizontal conveyance legs.

12. The food processing system of claim 7, wherein the horizontal conveyance legs are offset horizontally with respect to one another.

13-21. (canceled)

22. The food processing system of claim 1, the one or more electromagnetic wave units configured to emit energy when food products pass a triggering sensor.

23-24. (canceled)

25. The food processing system of claim 1, the one or more electromagnetic wave units configured to emit energy at a frequency from approximately 300 MHz to approximately 2550 Mhz.

26. The food processing system of claim 1, the one or more electromagnetic wave units configured to emit energy at a frequency of approximately 915 MHz or approximately 2450 Mhz.

27. The food processing system of claim 1, the one or more electromagnetic wave units configured to emit energy at a first frequency of approximately 915 MHz and a second frequency of approximately 2450 Mhz.

28. The food processing system of claim 1, wherein the electromagnetic wave heating chamber is configured to be at least partially filled with a fluid.

29-37. (canceled)

38. The food processing system of claim 1, comprising a plurality of retaining trays attached to the product conveyor mechanism.

39. The food processing system of claim 38, wherein each retaining tray is configured to hold a plurality of individual food containers laterally across the tray.

40. The food processing system of claim 1, the product conveyor mechanism forming a continuous loop.

41. The food processing system of claim 1, the system comprising a sterilization system.

42. The food processing system of claim 1, the system comprising a pasteurization system.

43. A method for sterilizing and/or pasteurizing food products comprising:
loading food products to be processed onto a conveyor;
passing the food products into a fluid filled electromagnetic wave heating chamber by movement of the conveyor;
the electromagnetic wave heating chamber defining a conveyance path, the conveyance path comprising a serpentine pathway, the serpentine pathway comprising a plurality of hairpin corners wherein a horizontal direction of the conveyance path is reversed and a depth of the conveyance path is increased;
the electromagnetic wave heating chamber further comprising an electromagnetic wave emitting apparatus configured to emit electromagnetic energy into the serpentine pathway, the electromagnetic wave emitting apparatus comprising one or more electromagnetic wave units; and
heating the food products with electromagnetic wave energy from the electromagnetic wave units as the food products pass through the electromagnetic wave heating chamber.
